(19) United States
(12) Patent Application Publication
(10) Pub. No.: US 2010/0288563 A1
(43) Pub. Date: Nov. 18, 2010

(54) METHODS OF USE OF PARTICULATE MATERIALS IN CONJUNCTION WITH BRAZE ALLOYS AND RESULTING STRUCTURES

(76) Inventor: Redd H. Smith, The Woodlands, TX (US)

Correspondence Address: TRASKBRITT, P.C., P.O. BOX 2550, SALT LAKE CITY, UT, 84110, US

(21) Appl. No.: 12/466,253

(22) Filed: May 14, 2009

(51) Int. Cl. E21B 10/60; E21B 10/42; B23K 31/02

(52) U.S. Cl. 175/393; 228/226; 228/244

(57) ABSTRACT

A component brazed to another, constraining component such as sleeve assembly brazed in a bore of a bit body. The braze joint includes particulate material in the gap between the components.

### TECHNICAL FIELD

The present invention relates generally to abrasive braze alloys and their methods of use in well tools, such as drill bits, their components and the like.

### BACKGROUND

Brazing is widely used to join materials by means of a filler material that melts upon heating and coats the surface of materials being joined, creating a bond upon cooling and solidification of the braze material. A suitable filler material wets the surfaces of the materials being joined and allows the materials to be joined without changing the physical properties of the materials. Braze materials generally melt at a low temperature in comparison to the melting temperature of the materials being joined. During a brazing process, heating and cooling of the materials may take place in the open atmosphere or in a controlled atmosphere furnace or vacuum furnace. Braze materials are often based on metals such as Ag, Au, Cu, Ni, Ti, Pd, Pt, Cr, and alloys thereof. Braze base materials may also include fractions of a wide variety of other elements that are added to vary the properties of the resulting alloy. Brazing can be used effectively to join similar or dissimilar materials, i.e., metals to metals, ceramics to ceramics, and metals to ceramics.

Typically, in a brazing process a filler metal or alloy is heated to a melting temperature above 800° F. and distributed between two or more close-fitting parts by direct placement of the filler material or drawn into the interface by capillary action. At the liquid temperature of a braze material, the molten filler metal interacts with the surface of the base metal, cooling to form a strong, sealed joint. In a brazed joint, the joint becomes a sandwich of different layers, each metallurgically linked to the adjacent layers.

Common braze joints may be less strong than the parent materials due either to the inherent lower yield strength of the braze alloy or to the low fracture toughness of inter-metallic components. Alternatively, brazed joints in some types of automotive sheet metal are substantially stronger that the surrounding strength of the sheet metal.

If a silver alloy is used, the brazing can be referred to as silver brazing. These silver alloys consist of many different percentages of silver and other compounds such as copper, zinc, and cadmium. Generally, silver brazing requires a gap between approximately 0.002 inches to 0.005 inches for proper capillary action during the joining of members.

In braze welding, the use of a bronze or brass filler rod coated with flux, together with an oxyacetylene torch are typically used to join pieces of steel,. Braze welding does not rely on capillary attraction. Braze welding takes place at the melting temperature of the filler (1600° F. to 1800° F. for bronze alloys) which is lower than the melting point of the base material (2900° F. for mild steel alloys).

Braze welding has advantages over fusion welding as it allows the joining of dissimilar metals, to minimize heat distortion, and reduce extensive preheating of the parts. A side effect of braze welding is that stored-up stresses in the parts being joined may be significantly reducted in contrast to that of fusion welding. However, braze welded joints have the disadvantages of loss of strength when subjected to high temperatures.

While given two joints with the same geometry, brazed joints are generally not as strong as welded joints, although a properly designed and executed brazed joint can be stronger than the parent metal. By careful matching of joint geometry to the forces acting on the joint and properly maintaining clearance between two mating parts being joined, the brazed joint can be a strong joint.

In drill bits used in subterranean boring, the sleeve of a nozzle assembly used to direct the flow of drilling fluid through the drill bit may be brazed in the drill bit body to provide an attachment means to retain the nozzle assembly therein. However, the nozzle assembly is subject to vibration and loading from the flow of drilling fluid therethrough may tend to cause the nozzle assembly to leave the drill bit body if the braze joint used to retain the nozzle assembly in the drill bit is not strong enough to retain the nozzle assembly in the drill bit body. Similarly, cutters for drill bits and pads or buttons which limit the depth of cut of a cutter in a drill bit are brazed on the drill bit. Therefore, it is desirable to develop brazed joints for materials which have the highest possible strengths.

### SUMMARY OF THE INVENTION

The present invention comprises the use of abrasive particles in braze alloys for increased joint strength between members, such as used in drill bits.

### BRIEF DESCRIPTION OF THE DRAWINGS

FIG. 1 shows a perspective, inverted view of a drill bit incorporating a nozzle assembly according to an embodiment of the invention.

FIG. 2 shows a cross-sectional view of the nozzle assembly in the drill bit as shown in FIG. 1.

FIG. 3 shows a cross-section view of a sleeve port in the drill bit as shown in FIG. 2.

FIG. 4 shows a cross-section view of a sleeve as shown in FIG. 2.

FIG. 5 shows a cross-section view of a nozzle assembly according to another embodiment of the invention.

### DETAILED DESCRIPTION OF THE INVENTION

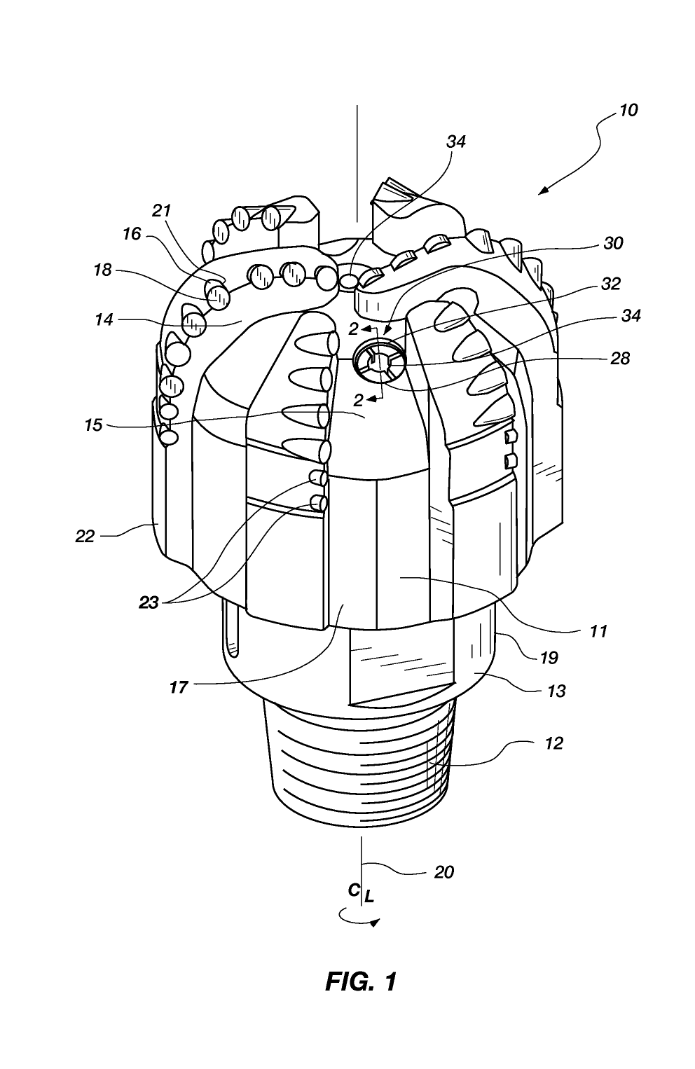

FIG. 1 shows a drill bit 10 incorporating a plurality of nozzle assemblies 30 according to one or more embodiments of the invention. The drill bit 10 is configured as a fixed cutter rotary full bore drill bit also known in the art as a “drag bit”. The drill bit 10 includes a bit crown or body 11 composed of sintered tungsten carbide coupled to a support 19. The support 19 includes a shank 13 and a crossover component (not shown) coupled to the shank 13 in this embodiment of the invention by using a submerged arc weld process to form a weld joint therebetween. The crossover component (not shown), which is manufactured from a tubular steel material, is coupled to the bit body 11 by pulsed MIG processes to form a weld joint therebetween in order to allow the tungsten carbide material to be securely retained to the shank 13. It is recognized that the support 19, particularly for other materials used to form a bit body, may be made from a unitary material piece or multiple pieces of material in a configuration differing from the shank 13 being coupled to the crossover by weld joints as presented. The shank 13 of the drill bit 10 includes conventional male threads 12 configured to API standards and adapted for connection to a component of a drillstring, not shown. The face 14 of the bit body 11 has mounted thereon a plurality of cutting elements 16, each comprising a polycrystalline diamond (PCD) table 18 formed on a cemented tungsten carbide substrate. The cutting elements 16, conventionally secured in respective cutter pockets 21 by brazing, for example, are positioned to cut a subterranean formation being drilled when the drill bit 10 is rotated under weight on bit (WOB) in a bore hole. The bit body 11 may include gage trimmers 23 including the aforementioned PCD tables 18 configured with a flat edge aligned parallel to the rotational axis 20 of the bit (not shown) to trim and hold the gage diameter of the bore hole, and gage pads 22 on the gage which contact the walls of the bore hole to maintain the hole diameter and stabilize the bit in the hole.

During drilling, drilling fluid is discharged through nozzle assemblies 30 located in sleeve ports 28 in fluid communication with the face 14 of bit body 11 for cooling the PCD tables 18 of cutting elements 16 and removing formation cuttings from the face 14 of drill bit 10 into passages 15 and junk slots 17. The nozzle assembly 30 in this embodiment includes a substantially tubular sleeve 32, a nozzle 34 and an O-ring seal (not shown) that may be received within a sleeve port 28 of the bit body 11. The nozzle 34 may be sized for different fluid flow volumes and velocities depending upon the desired flushing required at the PCD tables 18 of each group of cutting elements 16 to which a particular nozzle assembly directs drilling fluid. The inventive nozzle assembly of the invention may be utilized with new drill bits, or with drill bits that are appropriately modified and refurbished after use in the field. Use of a nozzle assembly 30 with a drill bit 10 as described herein enables removal and installation of nozzles in the field, and mitigates unwanted washout or erosion of the nozzle assembly 30, including the components of the nozzle assembly that may be caused by drilling fluid flow. An additional advantage of a nozzle assembly 30 used in conjunction with a drill bit 10 as described herein is in providing a means of establishing desired geometries and tolerances within the nozzle ports in sintered tungsten carbide bit bodies that are extremely difficult to obtain, if not impossible, because of shrinkage effects that are otherwise observed and manifested during manufacturing when sintering to obtain essentially full density in a bit body that has been machined in an unsintered state.

The bit crown or body 11 of the drill bit 10 may be formed from cemented carbide that may be coupled to the tubular crossover or support 19 by welding, brazing, soldering or other bonding techniques known by a person of skill in the art. The cemented carbide in this embodiment of the invention comprises tungsten carbide particles in a metal-based alloy matrix made by pressing a powdered tungsten carbide material, a powdered metal-based alloy material and admixtures, which may comprise a lubricant and organic additives such as wax, into what is conventionally known as a “green” body. As used herein, the term “metal-based alloy,” wherein [metal] may be any metal, means commercially pure metal in addition to metal alloys wherein the weight percentage of metal in the alloy is greater than the weight percentage of any other component of the alloy. A green body is relatively fragile, having enough strength to be handled for limited shaping operations, subsequent furnacing or sintering, but often not strong enough to handle impact or other stresses imparted by machining processes necessary to prepare the green body into a finished product. In order to make the green body strong enough for particular processes, the green body may then be partially sintered into what is conventionally known as a “brown state,” as known in the art of particulate or powder metallurgy, to obtain a brown body suitable for machining, for example. In the brown state, the brown body is not yet fully densified, but exhibits compressive strength suitable for more rigorous manufacturing processes, such as machining, while exhibiting a material state advantageous for obtaining features in the body that are not practicably obtained during forming or are more difficult and costly to obtain after the body is fully densified. Thereafter, the brown body is sintered to obtain a fully dense cemented bit.

As an alternative to tungsten carbide, one or more of diamond, boron carbide, boron nitride, aluminum nitride, tungsten boride and carbides, nitrides and borides of Ti, Mo, Nb, V, Hf, Zr, Ta, Si and Cr may be employed. Optionally, the matrix material may be selected from the group of iron-based alloys, nickel, nickel-based alloys, cobalt, cobalt-based alloys, cobalt- and nickel-based alloys, aluminum-based alloys, copper-based alloys, magnesium-based alloys, and titanium-based alloys may be employed. While the material of the body 11 as described may be made from a tungsten carbide with a cobalt matrix, other materials suitable for use in a bit body may also be utilized.

After the body is fully densified, post-machining process of boring may be used to obtain the final cylindrical shape of a sleeve port described below. In order to minimize the post-machining process, displacements, as known to those of ordinary skill in the art, may be utilized during final sintering to nominally control the shrinkage, warpage or distortion of pre-machined cylindrical features placed into the pre-densified body. While displacements may help to achieve nominal dimensions of the sleeve port 28 during final sintering of some materials thereby lessening the extent to which post-machining is required, invariably, critical component features, such as threads, are not suitably obtainable during densification of the body within the high degree of tolerances required. Furthermore, grinding or other machine operations may be required in order to obtain critical component features, such as threads, in the fully densified body. As discussed herein, the use of abrasive particles on braze alloys robustly provides for obtaining critical component features regardless of whether a displacement is used during the manufacturing process and without the need for a post-densification grinding of the sintered material to achieve dimensional accuracy of the critical component feature

While the drill bit 10 of this embodiment of the invention is a cemented bit, a drill bit in accordance with embodiments of the invention may include a matrix bit or a steel body bit as are well known to those of ordinary skill in the art, for example, without limitation. Drill bits, termed “matrix” bits, and as noted above are fabricated using particulate tungsten carbide infiltrated with a molten metal alloy, commonly copper-based. The advantages of the invention mentioned herein for “cemented” bits apply similarly to “matrix” bits. Steel body bits, again as noted above, comprise steel bodies generally machined from bars or castings, and may also be machined from forgings. While steel body bits are not subjected to the same manufacturing sensitivities as noted above, steel body bits may enjoy the advantages of the invention obtained during manufacture, assembly or retrofitting as described herein.

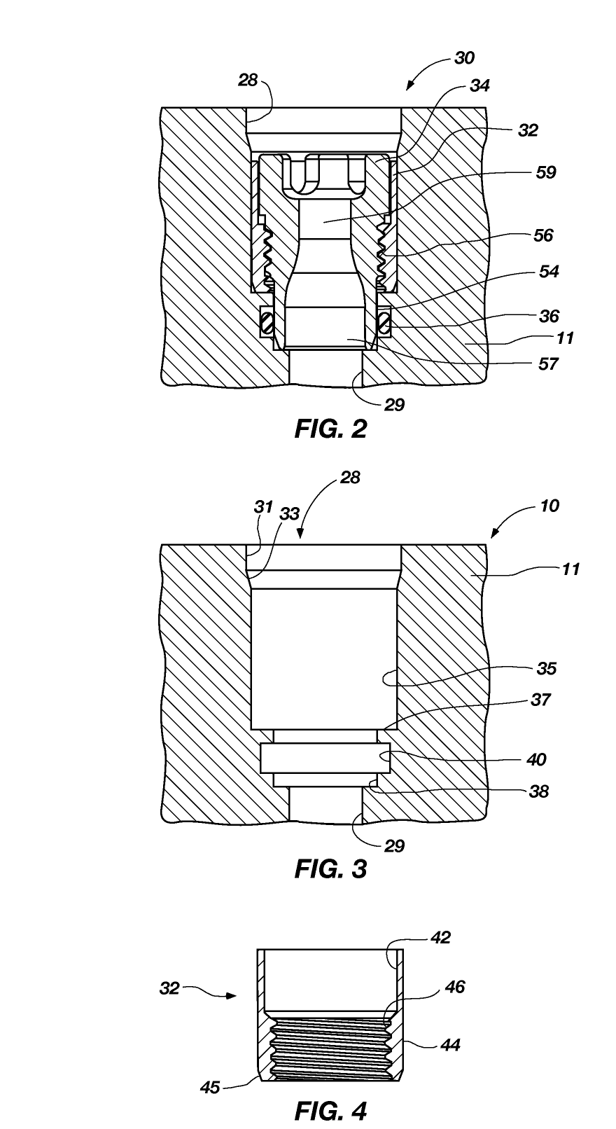

FIG. 2 shows a partial cross-sectional view of an embodiment of the nozzle assembly 30. Reference may also be made to FIGS. 1, 3 and 4. The nozzle assembly 30 in this embodiment includes a substantially tubular sleeve 32, a nozzle 34 and an O-ring seal 36 that may be received within a sleeve port 28 of the bit body 11. The sleeve port 28 provides a socket bounded by a substantially cylindrical internal surface in which components of the nozzle assembly 30 are received for communication of drilling fluid from chamber or plenum 29 within the bit body 11 to the face 14 of the drill bit 10 (FIG. 1). The tubular sleeve 32, which comprises a substantially cylindrical external surface, is mechanically retained within the sleeve port 28 by an interference as described below. As shown in FIG. 3, the sleeve port 28 includes within its circumference an exit port 31, a chamfer 33, a sleeve pocket 35, a sleeve seat 37, a seal groove 40, and a body nozzle port 38 and is configured for receiving the nozzle assembly 30. The exit port 31 is configured to be slightly larger than the sleeve pocket 35 to facilitate insertion of the tubular sleeve 32 into the sleeve port 28. Further, the chamfer 33 facilitates alignment and placement of the tubular sleeve 32 as it is coupled into the sleeve pocket 35. The sleeve seat 37 provides a stop for insertion of the tubular sleeve 32 configured to provide determinant depth positioning of the tubular sleeve 32 within the sleeve pocket 35 as it is inserted therein during assembly. The body nozzle port 38 includes a seal groove 40 circumferentially located therein and may receive a seal 36. The seal 36 may provide a barrier as it is compressed between the nozzle 34 and the sleeve port 28 thereby reducing or preventing flow of the drilling fluid around the external periphery of tubular sleeve 32 and thereby mitigating the effects of erosion caused by flow of the drilling fluid resulting from any pressure differential across the nozzle 34.

As shown in FIG. 4, the tubular sleeve 32 includes a nozzle port 42 having internal threads 46 configured for engaging external threads 56 of a nozzle 34 (see FIG. 2), as described below, and a cylindrical external surface 44. The external surface 44 may include an insertion chamfer 45 at one end thereof to facilitate insertion of the tubular sleeve 32 into the sleeve pocket 35 of the sleeve port 28. The internal threads 46 of the nozzle port 42 of the tubular sleeve 32 provide an improved connection with the nozzle 34 because the tubular sleeve 32 may be machined or cast to precision tolerances, which are difficult to obtain or maintain in the material of a “cemented” or “matrix” bit during its manufacture. Further, the diameter of external surface 44 may be customized easily to a particular size of a sleeve port 28, for example, by machining to a particular external dimension, allowing the dimensions of nozzle port 42 to be standardized for receiving nozzles.

The nozzle 34 includes an outer wall 54, external threads 56 on a portion thereof and an internal passageway or bore 57 through which drilling fluid flows from chamber or plenum 29, bore 57 to nozzle orifice 59. The nozzle 34 is removably insertable into the tubular sleeve 32 in coaxially engaging relationship therewith and is retained in the nozzle port 42 of the tubular sleeve 32 by engagement of its external threads 56 with internal threads 46 of the nozzle port 42 of the tubular sleeve 32. The seal 36 is sized and configured to be compressed between an outer wall of the seal groove 40 of the body nozzle port 38 and the external surface 44 of the tubular sleeve 32 to substantially prevent drilling fluid flow between the tubular sleeve 32 and a wall of the sleeve port 28, while the fluid flows through the nozzle assembly 30. In this embodiment, fluid sealing is provided between the nozzle 34 and the wall of sleeve port 28 below the engaged threads 46 and 56, but the seal may be provided elsewhere along the outer wall 54 of nozzle 34 and wall of the sleeve port 28, between the tubular sleeve 32 and the sleeve port 28 and or between the nozzle port 42 of the tubular sleeve 32 and the outer wall 54 of the nozzle 34. In this regard, additional seals may also be utilized to advantage as described in U.S. patent application Ser. No. 11/600,304 entitled “Drill Bit Nozzle Assembly, Insert Assembly Including Same and Method of Manufacturing or Retrofitting a Steel Body Bit for Use with the Insert Assembly,” assigned to the assignee of this patent application, and the disclosure of which is incorporated by reference herein, and may be utilized in embodiments of the invention.

The tubular sleeve 32 may comprise steel material, as known to those of ordinary skill in the art, to provide retention of the nozzle 34 while securely interfacing with the bit body 11. Optionally, other materials may be used for, or to line, the tubular sleeve 32, such as nonferrous metals and alloys thereof or ceramic materials.

The nozzle 34 may comprise tungsten carbide material, as known to those of ordinary skill in the art, to provide high erosion resistance to the drilling fluids being pumped through the nozzle assembly 30 at a high velocity. Optionally, other materials may be used for, or to line, the nozzle 34, such as other matrix composite materials, steels or ceramic materials.

Cermets may also be selected as a material for the bit body 11, the tubular sleeve 32 and the nozzle 34. Cermets are ceramic-metal composites. One cermet suitable for use with embodiments of the invention is cemented carbide comprising extremely hard particles of a refractory carbide ceramics including tungsten carbide or titanium carbide, embedded in a matrix of metals such as cobalt or nickel alloy or a steel alloy.

Advantageously in this embodiment of the invention, the steel material of the tubular sleeve 32 provides a primary support material suitable for being retained within the “cemented” carbide material of the sleeve port 28 of the bit body 11 through the use of suitable types of braze for attachment with the tungsten carbide material of the nozzle 34. By providing the tubular sleeve 32 brazed in the bit body 11, reworking of the threads 46 may be accomplished more easily or the tubular sleeve 32 may be removed and replaced without alteration to the bit body 11. Also, the tubular sleeve 32 simplifies attachment and replacement of the nozzle 34 by providing a higher quality engagement surface, i.e., the threads, within its body.

The seal groove 40 is shown as an open, annular channel of substantially rectangular cross section. However, the seal groove 40 may have any suitable cross-sectional shape. The effectiveness of seal groove 40 may be less affected by dimensional changes caused in the bit body 11 during final sintering because the seal 36 may adequately compensate for such changes by accommodating the resulting structure.

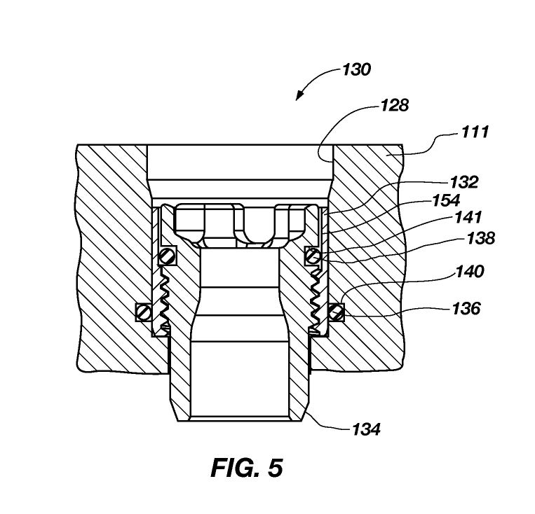

While the seal groove 40 is shown completely located within the material of the bit body 11 surrounding sleeve port 28, it may optionally be located in the outer wall 54 of the nozzle 34 and/or the external surface 44 of the tubular sleeve 32. The seal groove 40 may also be optionally formed partially within the material of the bit body 11 surrounding the sleeve port 28 and partially within the outer wall 54 of the nozzle 34 or the external surface 44 of the tubular sleeve 32, respectively, depending upon the type of seal used. Also, additional seal grooves and seals may optionally be used to advantage. For example, FIG. 5 shows a cross-sectional view of another embodiment of a nozzle assembly 130. The nozzle assembly 130 has a seal groove 140 located in a sleeve port 128 of a bit body 111 and another seal groove 141 located in an outer wall 154 of a nozzle 134, both sized and configured to receive seals 136, 138.

The seal 36 and seals 136 and 138 provide a seal to prevent drilling fluid from bypassing the interior of the tubular sleeve 32, 132 and flowing through any gaps at locations between components to eliminate the potential for erosion while avoiding the need for the use of joint compound, particularly between the threads 46, 56. The seals 36, 136, 138 may each comprise an elastomer or other suitable, resilient seal material or combination of materials configured for sealing, when compressed, under high pressure within an anticipated temperature range and under environmental conditions (e.g., carbon dioxide, sour gas, etc.) to which drill bit 10 may be exposed for the particular application. Seal design is well known to persons having ordinary skill in the art; therefore, a suitable seal material, size and configuration may easily be determined, and many seal designs will be equally acceptable for a variety of conditions. For example, without limitation, instead of an O-ring seal, a spring-energized seal or a pressure energized seal may be employed. Further, the seal material may be designed to withstand high or low temperatures expected during the assembly process of a sleeve into a bit body.

To enhance the retention of the sleeve within the sleeve port of the bit body 11 using braze, small particles of hard abrasive particles may be distributed between two substantially cylindrical parts that are to be coupled together by braze therebetween. The hard abrasive particles may be distributed in the braze material when formulated or when the braze material is molten to increase the shear strength of the braze bond of the sleeve within the sleeve port in the bit body 11. The size of the particles of the hard abrasive material should be smaller than a gap or clearance between the sleeve and the bit body 11 when the sleeve is inserted therein. The small particles, which may be introduced upon either part, either the sleeve or the body are used to lock the two parts together in order to provide an additional mechanical interference of the interfacial areas thereof and to change the retention strength of the two parts being bonded together by the molten braze. The small particles may be of any size suitable for providing interlocking between the two interfering parts, but must be small enough not to interfere with the assembly of the two parts, if the small particles are applied thereto prior to brazing. In one aspect, the small particles form a mechanical lock, or interface along the boundary between the two parts by an interfering fit therebetween by the hard abrasive particles gouging into the sleeve and the bit body 11. The hardness, density, shape, and size of the small particles will depend upon the retention strength desired, the composition of both parts to be mutually secured, and the composition of the small particles.

In the most basic application, either part may be coated with a fine particulate prior to assembly of the parts, after which the parts are assembled and braze applied thereto to provide the enhanced mechanical or interference fit. The particulate may be deposed on the mating surfaces either as a dry powder or as a slurry wherein the abrasive particulate is mixed with a carrier fluid such as, for example, water, oil, alcohols, polyols or other organic or silicon based fluids. Alternatively, the particulate may be mixed with the braze material and applied to the sleeve and the bit body 11. The particles penetrate the surfaces of the two joined parts after normalization of their temperatures after brazing thereof to provide additional retention force against mutual longitudinal displacement of one relative to the other.

One of the embodiments of the invention may include particles (not shown) of SiC grit, particles of metal, metal oxides, carbides, borides, and nitrides, including, but not limited to, alumina, silica, zirconia, boron nitride, boron carbide, aluminum nitride, magnesium oxide, calcium oxide, and diamond may be utilized to advantage.

The particles are harder than the steel material of the tubular sleeve 32 and at least as hard as the “cemented carbide” material of the sleeve port 28 in the bit body 11. When the tubular sleeve 32 is brazed within the sleeve port 28, the particles will provide additional mechanical locking therebetween while increasing the retention strength of the tubular sleeve 32 within the sleeve port 28. The increase in retention strength will provide an additional margin of safety, particularly when the drill bit 10 is subjected to pulsating pressures of the drilling fluid flow while drilling. Any suitable type of copper-, silver-, or nickel-based brazes can be used with the particles.

It is to be recognized that such particulates may be used to mutually secure other cylindrical parts such as PDC cutters into the bit body wherein enhanced retention strength is desired. In this regard, such an embodiment of the invention is not limited to the modality of nozzle assemblies or drill bits. Also, while an embodiment of the invention employs particles of SiC grit, other particles such as metals, metal oxides, carbides, borides, and nitrides, including, but not limited to, alumina, silica, zirconia, boron nitride, boron carbide, aluminum nitride, magnesium oxide, calcium oxide, and diamond may be utilized to advantage. Optionally, the particulate may range in size as based upon the percentage of available gap achieved during the interference assembly. In this regard, the particulate may range between 1% and 95% of the available gap size. The use of abrasive particles in a braze joint is for use in brazed joints that are constrained to shearing deformation. Such shear constrained motion allows the abrasive particles to score the softer substrate materials of a brazed joint and creates a mechanical locking mechanism in the braze joint between the abrasive particles and the softer substrate materials.

In order to facilitate a more even dispersion of the particles, a carrier fluid may be used in order to apply the particles upon either of the two interfacial areas of the parts. The particles may be suspended in a carrier fluid such as an alcohol, and then applied to either of the parts; preferably the cooler of the two parts and then assembled as noted above. The carrier fluid enables an improved or more uniform coverage of the particles upon the interfacial areas of the parts. The carrier fluid should be selected so as to not influence the interference fit. In embodiments of the invention, the carrier fluid will be desirably dissipated, as by vaporization or combustion, for example, without limitation, when exposed to the higher temperature part while the parts begin to equalize in temperature.

While the invention has been described with respect to the use of particles in braze for a sleeve in a drill bit body, the invention is not so limited and may be used in brazing other components of drill bits and other articles of manufacture.

While particular embodiments of the invention have been shown and described, numerous variations and other embodiments will occur to those skilled in the art. Accordingly, it is intended that the invention be limited in terms of the appended claims.

1. A nozzle assembly for a drill bit for subterranean drilling, the nozzle assembly comprising:
a bit body comprising at least one sleeve port having an internal surface;
a substantially tubular sleeve disposed in the at least one sleeve port of the bit body, the tubular sleeve comprising an internal nozzle port and an external surface;
braze material having particulate material therein disposed between the internal surface of the at least one sleeve port of the bit body and the external surface of the tubular sleeve, some of the particulate material engaging at least one of the internal surface of the at least one sleeve port and the external surface of the tubular sleeve; and
a nozzle comprising an erosion-resistant material disposed in the internal nozzle port.

2. The nozzle assembly of claim 1, wherein the particulate material comprises a cermet or a ceramic.

3. The nozzle assembly of claim 1, wherein the particulate material comprises silicon carbide.

4. The nozzle assembly of claim 1, wherein the particulate material comprises diamond.

5. The nozzle assembly of claim 1, wherein the particulate material disposed between the internal surface of the at least one sleeve port of the bit body and the external surface of the tubular sleeve comprises a portion of residue of a carrier fluid used to suspend the particulate material prior to the disposition thereof.

6. The nozzle assembly of claim 2, wherein a size of the cermet or ceramic particles is between 1% and 95% of a size of a gap between the internal surface of the at least one sleeve port of the bit body and the external surface of the tubular sleeve when an available gap size ranges between one thousandth (0.001″) and ten thousandths (0.010″) of an inch prior to the tubular sleeve being disposed in the at least one sleeve port of the bit body.

7. The nozzle assembly of claim 3, wherein a size of the silicon carbide particles is between 1% and 95% of a size of a gap between the internal surface of the at least one sleeve port of the bit body and the external surface of the tubular sleeve when an available gap size ranges between one thousandth (0.001″) and ten thousandths (0.010″) of an inch prior to the tubular sleeve being disposed in the at least one sleeve port of the bit body.

8. The nozzle assembly of claim 4, wherein a size of the diamond particles is between 1% and 95% of a size of a gap between the internal surface of the at least one sleeve port of the bit body and the external surface of the tubular sleeve when an available gap size ranges between one thousandth (0.001″) and ten thousandths (0.010″) of an inch prior to the tubular sleeve being disposed in the at least one sleeve port of the bit body.

9. The nozzle assembly of claim 1, wherein a size of particles of the particulate material comprises between 1% and 95% of a size of a gap between the internal surface of the at least one sleeve port of the bit body and the external surface of the tubular sleeve when an available gap size ranges between one thousandth (0.001″) and ten thousandths (0.010″) of an inch prior to the tubular sleeve being disposed in the at least one sleeve port of the bit body.

10. The nozzle assembly of claim 1, wherein particles include a particle size of about fifty microns.

11. The nozzle assembly of claim 1, wherein the braze comprises one of a copper-based braze, a silver-based braze, and a nickel-based braze.

12. The nozzle assembly of claim 1, wherein particles comprise one of SiC grit, particles of metal, metal oxides, carbides, borides, and nitrides.

13. The nozzle assembly of claim 12, wherein the particles include alumina, silica, zirconia, boron nitride, boron carbide, aluminum nitride, magnesium oxide, calcium oxide, and diamond.

14. An assembly for an oil tool for subterranean use comprising:
a body comprising at least one port having an internal surface;
a substantially tubular sleeve disposed in the at least one port of the body, the tubular sleeve comprising an external surface; and
braze material having particulate material therein disposed between the internal surface of the at least one port of the body and the external surface of the tubular sleeve, some of the particulate material engaging the internal surface of the at least one port and the external surface of the tubular sleeve.

15. The assembly of claim 14, wherein the particulate material comprises a cermet or a ceramic.

16. The assembly of claim 14, wherein the particulate material comprises silicon carbide.

17. The assembly of claim 14, wherein the particulate material comprises diamond.

18. The assembly of claim 14, wherein the particulate material disposed between the internal surface of the at least one sleeve port of the bit body and the external surface of the tubular sleeve comprises a portion of residue of a carrier fluid used to suspend the particulate material prior to the disposition thereof.

19. The assembly of claim 18, wherein a size of the cermet or ceramic particles is between 1% and 95% of a size of a gap between the internal surface of the at least one sleeve port of the bit body and the external surface of the tubular sleeve when an available gap size ranges between one thousandth (0.001″) and ten thousandths (0.010″) of an inch prior to the tubular sleeve being disposed in the at least one sleeve port of the body.

20. The assembly of claim 16, wherein a size of the silicon carbide particles is between 1% and 95% of a size of a gap between the internal surface of the at least one sleeve port of the bit body and the external surface of the tubular sleeve when an available gap size ranges between one thousandth (0.001″) and ten thousandths (0.010″) of an inch prior to the tubular sleeve being disposed in the at least one sleeve port of the body.

21. The assembly of claim 17, wherein a size of the diamond particles is between 1% and 95% of a size of a gap between the internal surface of the at least one sleeve port of the bit body and the external surface of the tubular sleeve when an available gap size ranges between one thousandth (0.001″) and ten thousandths (0.010″) of an inch prior to the tubular sleeve being disposed in the at least one sleeve port of the body.

22. The assembly of claim 14, wherein a size of particles of the particulate material comprises between 1% and 95% of a size of a gap between the internal surface of the at least one sleeve port of the bit body and the external surface of the tubular sleeve when an available gap size ranges between one thousandth (0.001″) and ten thousandths (0.010″) of an inch prior to the tubular sleeve being disposed in the at least one sleeve port of the body.

23. The assembly of claim 14, wherein the braze comprises one of a copper-based braze, a silver-based braze, and a nickel-based braze.

24. The assembly of claim 14, wherein the particles comprise one of SiC grit, particles of metal, metal oxides, carbides, borides, and nitrides.

25. The assembly of claim 24, wherein the particles include alumina, silica, zirconia, boron nitride, boron carbide, aluminum nitride, magnesium oxide, calcium oxide, and diamond.

26. A method of applying braze material to a gap between a bore in a body and an insert comprising:
applying particulate material to one of the bore in a body and the exterior surface of an insert; and
applying braze material to the gap.

27. The method of claim 26, further comprising mixing the particulate material in a carrier before the application thereof.

28. A method of applying braze material to a gap between a recess in a body and an insert comprising:
applying particulate material to the recess in a body and the exterior surface of an insert;
placing at least a portion of the insert within the recess, defining a gap therebetween; and
applying braze material to the gap.

29. The method of claim 28, further comprising mixing the particulate material in a carrier before the application thereof.

30. A method of applying braze material to a gap between a recess in a body and an insert comprising:
mixing particulate material in the braze material; and
applying the braze material to a gap between the recess and at least a portion of the insert.

31. The method of claim 30, further comprising mixing the particulate material in a carrier before the application thereof.

32. A nozzle assembly for a drill bit for subterranean drilling, the nozzle assembly comprising:
a bit body comprising at least one sleeve port having an internal surface having particulate material in contact therewith;
a substantially tubular sleeve disposed in the at least one sleeve port of the bit body, the tubular sleeve comprising an internal nozzle port and an external surface having particulate material in contact therewith;
braze material containing portions of particles of the particulate material in contact with the internal surface and the external surface disposed between the internal surface of the at least one sleeve port of the bit body and the external surface of the tubular sleeve; and
a nozzle comprising an erosion-resistant material disposed in the internal nozzle port.

33. An assembly comprising:
a body comprising at least recess having an internal surface having particulate material in contact therewith;
a component at least partially disposed in the at least one recess of the body, the component comprising an external surface having particulate material in contact therewith; and
braze material having disposed between the internal surface of the at least one port of the body and the external surface of the tubular sleeve, portions of particles of the particulate material in contact with the internal surface and the external surface located in the braze material.

34. The assembly of claim 1, wherein the particulate material comprises particles having a hardness greater than a hardness of at least one of the internal surface and the external surface.
